(19) United States
(12) Patent Application Publication
(10) Pub. No.: US 2026/0107058 A1
(43) Pub. Date: Apr. 16, 2026

(54) GUIDED PHOTOGRAPHY FOR VEHICLES USING STENCIL AND ALIGNMENT ALGORITHM BASED ON ML TECHNIQUES

(71) Applicant: Capital One Services, LLC, McLean, VA (US)

(72) Inventors: Debashish ROY, Bangalore (IN); Harsimran Jot Singh BASRA, Bangalore (IN); Aditya KAMAL, Bengaluru (IN); Amrit Presanna KUMAR, Bangalore (IN); Vishwajeet Shrikrishna LOHAKAREY, Bangalore (IN); Anuj CHAUDHARY, Bangalore (IN); Dontula KARTHIK, Bangalore (IN)

(73) Assignee: Capital One Services, LLC, McLean, VA (US)

(21) Appl. No.: 18/911,623

(22) Filed: Oct. 10, 2024

(51) Int. Cl. H04N 23/60; H04N 23/61; H04N 23/63

(52) U.S. Cl. CPC H04N 23/64; H04N 23/61; H04N 23/632; H04N 23/635

(57) ABSTRACT

A computer implemented method, system, and non-transitory computer-readable device for a guided image capture environment. In some embodiments, custom stencils may be generated to provide tailored fine-grained guidance during image capture. A guided image capture system may augment an image capture preview display using a generated custom stencil corresponding to a specific type of object. In some embodiments, the guided image capture system may determine from an image frame that an object is aligned within the augmented custom stencil. In some embodiments, the guided image capture system may store the image frame upon determining that the object is aligned within the custom stencil.

### BACKGROUND

Image capture has become widespread in modern devices. This technology has revolutionized how we document and share information with one another. As image capture technology evolves, so have the demands for specific image quality and standardization in different fields. However, current image capture systems face certain challenges with enforcing certain limitations, such as image quality, authenticity, and format.

### BRIEF DESCRIPTION OF THE DRAWINGS

The accompanying drawings are incorporated herein and form a part of the specification.

FIG. 1 illustrates an example block diagram of a guided image capture system architecture, according to some embodiments.

FIG. 2 illustrates an example block diagram of a client device, according to some embodiments.

FIG. 3 illustrates example model images, according to some embodiments.

FIG. 4 illustrates example images taken without a guided image capture system, according to some embodiments.

FIG. 5 illustrates example images taken with a guided image capture system, according to some embodiments.

FIG. 6 illustrates an example custom stencil, according to some embodiments.

FIG. 7 illustrates another example custom stencil, according to some embodiments.

FIG. 8 illustrates an example image capture preview augmentation, according to some embodiments.

FIG. 9 illustrates an example object part classification, according to some embodiments.

FIG. 10 illustrates an example flow diagram for capturing an image with a guided image capture system, according to some embodiments.

FIG. 11 illustrates an example flow diagram for generating a custom stencil, according to some embodiments.

FIG. 12 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing a guided image capture system, which may assist a user with capturing images according to desired specifications. The guided image capture system may be used to capture a standardized, high-quality image for transmitting to a central repository or marketplace, for example.

Image capture systems have become widespread in modern devices, allowing users to freely capture images. However, this freedom creates problems in contexts where specific image standards or formats are needed. For example, the fields of e-commerce, medical imaging, and quality control often require images to meet certain guidelines or specifications. These guidelines may include specific standards for image quality, angle, and lighting. In the case of the e-commerce field, online marketplace managers may require images submitted by multiple vendors to follow certain image capture conventions to provide cohesive user experience and present products in a uniform and professional manner. A standardized format may be especially beneficial for reconciling images of the same product submitted by separate vendors. Current systems lack inherent mechanisms for enforcing these standards during the image capture process.

This technological gap in current systems may cause additional issues. First, even when provided with instructions, users may each interpret those instructions differently and capture inconsistent, unstandardized images. Sometimes the instructions themselves may not clearly convey the intended format or angle and simply ask the user to retake images until a satisfactory image is found. This may lead to user frustration from needing to retake images using unclear instructions. As a result, image capture processes may be delayed and processing power may be wasted.

Second, some contexts may require image authenticity or verification. As a result, tools such as image filters or image editing become unavailable as potential solutions for enhancing image quality. For example, online marketplaces may require product images across different vendors to be real in addition to adhering to a consistent format for the cohesive user experience. In another example, online marketplaces may disallow vendors from adding promotional edits, such as text banners. Allowing users to submit artificially enhanced images may result in an unfair, dishonest and/or disorganized marketplace environment.

Third, obtaining high-quality and standardized images has traditionally required professional equipment and expertise, creating a technological barrier of entry. For example, taking stock images or professional images of products may involve using certain types of cameras, lighting equipment, etc. While efforts have been made to develop more accessible hardware solutions, these solutions still require users to make additional purchases and may still not adequately address the problem of obtaining standardized, authentic images in different environments.

The technology described in the various embodiments herein implements a guided image capture system for producing user images according to a desired, standardized format. In some embodiments, an image capture system may first identify a type of an object using object identification information. The image capture system may then retrieve a custom stencil from a data store corresponding to the object type. The image capture system may then augment an image capture preview display with the custom stencil. The image capture system may then determine from an image frame of the image capture preview display that the object is aligned within the custom stencil. Upon determining that the object is aligned within the stencil, the image capture system may store the image frame of the object, thereby producing the standardized image.

In some embodiments, the image capture system may generate the custom stencil based on the type of the object. The image capture system may first receive a model image corresponding to the type of the object. The image capture system may then segment one or more parts of the object from the model image. From the segmented object parts, the image capture system may generate one or more stencils corresponding to each segmented object part. Finally, the image capture system may overlay the one or more corresponding stencils to obtain the custom stencil for the entire object. In some embodiments, the image capture system may determine one or more bounding boxes corresponding to the segmented parts of the object. The image capture system may also determine metadata for the object from the determined bounding boxes.

In some embodiments, the image capture system may adjust the custom stencil to a user device based on a resolution of the device. For example, the image capture system may adjust a custom stencil from the base resolution of the custom stencil to match the resolution of the device. In some embodiments, the image capture system may also scale the metadata stored alongside the custom stencil using a scaling factor.

In some embodiments, the image capture system may determine that the object is aligned with the custom stencil by using the metadata associated with the object. For example, the metadata may include coordinate position data corresponding to each of the one or more parts of the object. The metadata may also include a bounding box size. The image capture system may crop the image frame based on the metadata to obtain one or more cropped images. The image capture system may determine whether the one or more cropped images include the corresponding part of the object using one or more machine learning (ML) models. If each of the cropped image sections include the corresponding part of the object, the image capture system may determine that the entire object is indeed aligned with the custom stencil.

In some embodiments, the ML model(s) may operate on a user's mobile device (e.g., a mobile phone). In some embodiments, the ML model(s) may be trained using supervised or semi-supervised learning, for example, by providing a collection of categorized images (e.g., desired/undesired images) of cropped sections to an untrained or partially trained model to train a predictive ML model (e.g., a classification model and/or regression model). Upon being provided the cropped images section, the predictive ML model(s) may be configured to provide a likelihood that the cropped image section contains the target object or part of the object (e.g., a confidence score).

While described throughout for image classification and/or regression performed on the client device, in some embodiments, the image or live stream of imagery may be communicated to one or more remote servers, computing devices or cloud-based systems for performing a remote image assessment, wherein the predictive ML model(s) may operate on the one or more remote servers, computing devices or cloud-based systems. In such embodiments, the predictive ML model(s) may still determine a likelihood that the cropped image section contains the target object or part of the object.

ML involves computers discovering how they can perform tasks without being explicitly programmed to do so. ML may include, but is not limited to, artificial intelligence, deep learning, fuzzy learning, supervised learning, unsupervised learning, etc. Machine learning algorithms may build a model based on sample data, known as “training data,” in order to make predictions or decisions without being explicitly programmed to do so. For supervised learning, the computer may be presented with example inputs and their desired outputs and the goal is to learn a general rule that maps inputs to outputs. In another example, for unsupervised learning, no labels may be given to the learning algorithm, leaving it on its own to find structure in its input. Unsupervised learning can be a goal in itself (discovering hidden patterns in data) or a means towards an end (feature learning).

A machine learning engine (e.g., operating on ML platform 126) may use various classifiers to map concepts associated with a specific image capture to capture relationships between concepts (e.g., cropped image sections vs. desired part of an object). The classifier or discriminator may be trained to distinguish or recognize variations. Different variations may be classified to ensure no collapse of the classifier and so that variations can be distinguished.

In some embodiments, machine learning models may be trained on a remote machine learning platform (e.g., ML platform 126) using model images of objects or other users'images of objects (e.g., previously submitted images). In addition, large training sets of the other user's historical information may be used to normalize prediction data (e.g., not skewed by a single or few occurrences of a data artifact). Thereafter, predictive ML model(s) may assess a specific image frame or cropped image against the trained predictive model to determine whether the image frame or cropped image contains the desired object or object part. In some embodiments, the predictive ML model(s) may be continuously updated as new user submissions occur.

In some embodiments, a ML engine may continuously change weighting of model inputs to increase accuracy of the predictive ML model(s). For example, weighting of specific data fields may be continuously modified in the model to trend towards greater accuracy, where accuracy is recognized by correct predictions of whether an image or cropped image contains a desired object or object part. Conversely, term weighting that lowers accuracy may be lowered or eliminated.

In some embodiments, the ML engine may operate on, and machine learning models may be trained on, a mobile machine learning platform (e.g., mobile ML platform 112). In such embodiments, the machine learning models may be trained on a single user's submitted images (e.g., previously submitted images). The machine learning models may also be trained on various non-user image data sources. In one non-limiting example, the ML engine may be trained on images that been compiled or scraped from one or more online data sources. In another example, the ML engine may be trained on images that have been prepared during an application development phase. Different sets of images may be used to train or refine the ML engine. As new data is obtained from the various data source, new datasets may be created for refining the ML engine. Subsequent refined versions of the ML engine with updated model weights and parameters may then be implemented (e.g., via a software update).

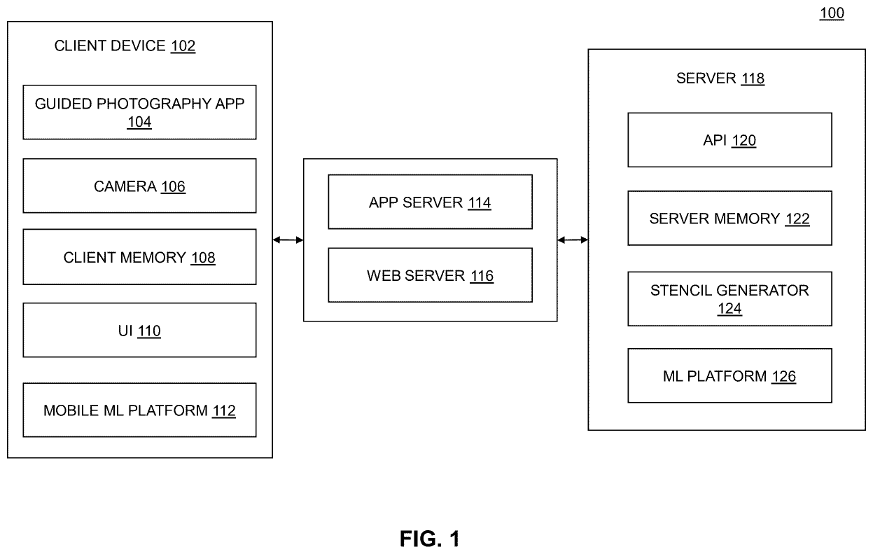

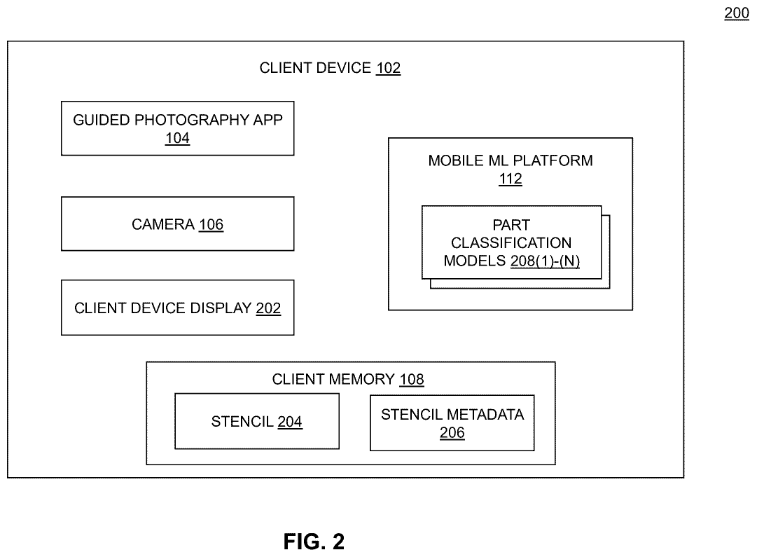

Various embodiments of this disclosure may be implemented using and/or may be a part of an image capture system shown in FIGS. 1-2. It is noted, however, that this environment is provided solely for illustrative purposes, and is not limiting. Embodiments of this disclosure may be implemented using and or may be part of environments different from and/or in addition to the image capture system, as will be appreciated by persons skilled in the relevant art(s) based on the teachings contained herein.

Variations of the devices disclosed herein are contemplated. For example, in a client computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

A client computing device may also include software and internal sensors (e.g., gyroscopes, accelerometers, magnetometers, and/or LiDAR sensors, ToF sensors, etc.) that may determine a real world position and orientation of various objects within the field of view of a camera both relative to a real world coordinate system and relative to camera, for example, with an augmented reality (AR) platform. Using an AR platform, the client computing device may obtain depth data on the real world distance between a plane detected in the field of view of the camera, for example, by leveraging plane detection and calculating distance to the center or a surface of the plane using the plane's coordinates. In some embodiments, the distance may be determined from an output of a LiDAR sensor or ToF sensor. In some embodiments, alternatively or additionally, distance from the camera to an object in an image may be determined using multiple lenses and/or cameras on the client device, where data from each of which may be compared to obtain depth data. For example, the difference in location of an object within two images captured using two lenses on the same device may be used to calculate distance to the object from the lenses. Depth information may be leveraged for a variety of tasks such as, but not limited to, generating three-dimensional models from one or more two-dimensional images.

In one non-limiting example, guided image capture processes may benefit from image object builds generated by one or more, or a combination of cameras or lenses. For example, multiple cameras or lenses may separately, or in combination, capture specific blocks of imagery for objects and/or parts of objects that are present, at least in part, within the field of view of the cameras. In another example, multiple cameras or lenses may capture more light than a single camera or lens, resulting in better image quality. In another example, individual lenses, or a combination of lenses, may generate depth data for one or more objects or parts of objects located within a field of view of the camera.

An example of the image capture system shall now be described.

FIG. 1 illustrates a guided image capture system architecture 100, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

A client device 102 may implement guided image capture for one or more images of objects. The client device 102 may be configured to communicate with a server 118 to complete various phases of a guided image capture as will be discussed in greater detail hereafter.

In some embodiments, server 118 may be implemented as one or more servers and/or one or more cloud servers. Server 118 may also be implemented as a variety of centralized or decentralized computing devices. For example, server 118 may be a mobile device, a laptop computer, a desktop computer, grid-computing resources, a virtualized computing resource, cloud computing resources, peer-to-peer distributed computing devices, a server farm, or a combination thereof. Server 118 may be centralized in a single device, distributed across multiple devices within a cloud network, distributed across different geographic locations, or embedded within a network. Server 118 may communicate with other devices, such as a client device 102. Components of server 118, such as Application Programming Interface (API) 120, server memory 122, stencil generator 124, and ML platform 126, may be implemented within the same device (such as when a server 118 is implemented as a single device) or as separate devices (e.g., when server 118 is implemented as a distributed system with components connected via a network).

Guided photography app 104 may be a computer program or software application designed to run on a mobile device such as a phone, tablet, or watch. However, in a desktop application, a desktop equivalent of the guided photography app may be configured to run on desktop computers, and web applications, which run in mobile web browsers rather than directly on a mobile device, may be implemented for guided photography app 104. Applications or apps may be broadly classified into three types: native apps, hybrid, and web apps. Native applications may be designed specifically for a mobile operating system, such as iOS or Android. Web apps may be designed to be accessed through a web browser. Hybrid apps may be built using web technologies such as JavaScript, CSS, and HTML5 and function like web apps disguised in a native container.

In some embodiments, guided photography app 104 may include executable software that may communicate with various systems within client device 102 to provide ML functionality. For example, ML frameworks, for example, those provided by Core ML (iOS) or ML Kit (Android or iOS), may be implemented to establish communications between guided photography app 104 and client device 102's ML capabilities. Guided photography app 104 may include software instructions that interact with application programing interfaces (APIs), programs, libraries, and/or modules of an ML framework. When executed, instructions on guided photography app 104 may cause ML models implemented by the ML framework and operating on client device 102 to receive and assess image data. As an example, guided photography app 104 may execute an API call to a Core ML or ML Kit framework to run an image classification ML model and obtain an image classification and/or a confidence score associated with the classification (e.g., using the Vision framework supported by ML Core or the MLKitVision framework provided by ML Kit). The image classification ML model may receive image pixel data gathered via a camera of client device 102, along with image metadata in some embodiments. The image classification ML model may alternatively or additionally receive image pixel data of cropped image sections. The image classification ML model may determine, based on the image pixel data and/or image metadata, whether the image pixel data contains a desired object or object part and may provide its determination to guided photography app 104. In some embodiments, a classification may be provided along with a confidence score indicating a likelihood the classification is correct. In some embodiments, a classification of whether or not the image pixel data contains a desired object or object part, with or without a confidence score, may be provided by the image classification ML model. While image classification ML models are discussed, any predictive ML model may be implemented using Core ML and ML Kit frameworks.

While Core ML and ML Kit are discussed above as example ML frameworks/software development kits (SDKs), it should be understood that any suitable ML framework or SDK may be implemented. Various functions of the ML framework(s) implemented may be integrated with guided photography app 104 or may operate on client device 102 but be separate from guided photography app 104.

Images of objects may originate from any of, but not limited to, image streams (e.g., series of pixels or frames) or video streams or a combination of any of these or future image formats. A user using a client device 102, operating a guided photography app 104 through an interactive UI 110, may frame at least a portion of an object with a camera 106 (e.g., within the field of view). In some embodiments, guided photography app 104 may embed a custom stencil within an image capture preview display of client device 102, for example within UI 110, prompting the user to frame at least a portion of an object within the custom stencil with camera 106. In some embodiments, imagery may processed from live stream object imagery, as communicated from camera 106 over a period of time, until an image assessment has been completed.

In some embodiments, image data may be assembled into one or more frames of image content. In some embodiments, a data signal from a camera sensor (e.g., a charge-coupled device (CCD) or an active-pixel sensor (such as a complementary metal-oxide-semiconductor (CMOS) image sensor)) may notify guided photography app 104 and/or mobile ML platform 112 when an entire sensor has been read out as streamed data. In this approach, the camera sensor may be cleared of electrons before a subsequent exposure to light and a next frame of an image is captured. This clearing function may be conveyed to guided photography app 104 and/or mobile ML platform 112 to indicate that a Byte Array Output Stream object constitutes a complete frame of image data. In some embodiments, images formed into a byte array may be first rectified to correct for distortions based on an angle of incidence, may be rotated to align the imagery, may be filtered to remove obstructions or reflections, and/or may be resized to correct for size distortions using known image processing techniques.

In some embodiments, the camera imagery may be streamed as encoded text, such as a byte array. Alternatively, or in addition, one or more frames of the live imagery may be stored (e.g., at least temporarily) as images in computer memory. For example, one or more frames of live streamed object imagery from camera 106 may be stored locally in client memory 108, which may be, but is not limited to, a frame buffer, a video buffer, a streaming buffer, a virtual buffer, a hard drive, etc.

In some embodiments, image data may be stored in any known file format, for example, as a JPEG, PNG, TIFF, HEIC, or RAW file, or any other file type that supports metadata storage, before being provided to mobile ML platform 112. In some embodiments, metadata may be stored in a variety of formats within an image file, including one or more of EXIF, XMP, XML, 8BIM, IPTC, or ICC formats.

Mobile ML platform 112, which in some embodiments may be resident on the client device 102, may process one or more images (e.g., image frames extracted from a live image stream) received from camera 106 and/or client memory 108 to determine whether or not the image of an object or object part contains a desired object or object part. In some embodiments, the image assessment process may be completed before finalization of a guided photography operation. Accordingly, in such embodiments, an image acceptance status may be communicated to or determined by guided photography app 104 for display on UI 110 before the one or more images are forwarded for further processing. In some embodiments, mobile ML platform 112 may include one or more ML frameworks which may implement predictive ML models (e.g., image classification ML models or regression ML models, etc.), as discussed in more detail with respect to FIG. 2.

Mobile ML platform 112 (e.g., ML framework(s) operating on mobile ML platform 112) may communicate with server 118. For example, mobile ML platform 112 may communicate with server 118 to receive trained ML models and/or provide data to server 118 that may be used in continuous training of ML models deployed on client device 102 (e.g., a history of predictions, confidence scores, images, and/or image metadata). In some embodiments, such data may be communicated to server memory 122 either through an app server 114 or web server 116 depending on the configuration of the client device (e.g., mobile or desktop). In some embodiments, such data may be communicated through the guided photography app 304.

In some embodiments, mobile ML platform 112 may include capabilities for federated learning. Federated learning may refer to a sub-class of machine learning that decentralizes the training of machine learning models. For example, mobile ML platform 112 may allow multiple entities to collaboratively train a machine learning model by downloading a pre-trained foundation model or partially trained model from server 118 to their local device (e.g., client device 102 and/or other client devices that are not shown). The entities may then train the models on locally stored data and send encrypted model weights back to server 118. There, the encrypted results from the various entities may be averaged and incorporated into a summarized model on ML platform 126. The resultant model may then be used by any entity thereafter. Federated learning may be useful for decentralizing the training process and protecting sensitive training data. As a result, federated learning may provide a secure method for training ML models on additional data, thereby generating improved models, all while maintaining data security. Additionally, training across multiple entities may be parallelized, which can lead to faster overall training times and reduced overall computations.

Alternatively, or in addition, in some embodiments, a thin client (not shown) resident on the client device 102 may implement ML models or ML model training as disclosed herein to provide local image assessment with assistance from server 118. For example, a processor (e.g., CPU) may implement at least a portion of image assessment using resources stored on a remote server instead of a localized memory. The thin client may connect remotely to the server-based computing environment (e.g., server 118) where applications, sensitive data, and memory may be stored.

API 120 may be an intermediary software interface between guided photography app 104, installed on client device 102, and one or more server systems of server 118, as well as third party servers (not shown). API 120 may be available to be called by mobile clients through a server, such as a mobile edge server (not shown), within server 118. Server memory 122 may store files received from the client device 102 or generated as a result of processing a guided photography.

ML platform 126 may include a predictive ML model and/or a ML engine to train a predictive ML model used to assess images to determine whether or not the image of an object or object part contains a desired object or object part. ML platform 126 may also include and/or train ML models to perform object segmentation tasks and bounding box generation tasks. For example, while the above disclosure has focused on a predictive ML model operating on client device 102, in some embodiments, the predictive ML model(s), segmentation models, and bounding box generation models may operate on ML platform 126. In such embodiments, guided photography app 104 may communicate an image, via app server 114 and/or API 120, to the predictive ML model running on ML platform 126. The predictive ML model running on ML platform 126 may return an image classification result and/or associated confidence score to guided photography app 104 in real time (e.g., within a current guided photography session). In some embodiments, the segmentation model(s) and/or bounding box generation model(s) running on ML platform 126 may perform segmentation tasks and bounding box generation tasks when generating custom stencils from images.

In some embodiments, ML platform 126 may be used to train one or more predictive ML models that may then be made available to guided photography app 104 via mobile ML platform 112. In such embodiments, ML platform 126 may include or implement ML platforms such as Create ML (Mac), TensorFlow (Windows), or any suitable platform for training ML models.

In some embodiments, ML platform 126 may include software produced and implemented by the entity providing guided photography app 104, and not third-party software. Alternatively, or in addition, ML platform 126 may include software produced and implemented by a third party. ML platform 126 may also include a proxy that connects to open-source or closed-source APIs.

ML platform 126 and mobile ML platform 112 may be in communication for the training and refinement of ML models implemented by mobile ML platform 112. For example, ML algorithms may be trained on ML platform 126 using training data, which may include images captured by client device 102. A resulting ML model may be provided to client device 102. Additionally, the ML model may be continuously refined. In some embodiments, the ML model may be refined on ML platform 126 based on training data that may be provided to ML platform 126 by client device 102 or data stored on server memory 122. In some embodiments, an ML model refined at ML platform 126 may be provided to client device 102 and may be accessible in new versions of guided photography app 104 (i.e., the refined model may be provided as part of a software update).

Stencil generator 124 may employ various ML models to generate custom stencils for objects corresponding to a type of those objects. To generate a custom stencil, stencil generator 124 may first receive a model image or target image of an object according to a specific type. The type of the object may be any property of the object that can differentiate that object from objects of a different type. For example, to generate a custom stencil for a large sedan vehicle, stencil generator 124 may obtain a stock image of a vehicle with type “large sedan.” A vehicle type may also include a make of the vehicle, a model of the vehicle, and/or a trim of the vehicle. In some embodiments, model or target images may be stored inside server memory 122. Model or target images may also be transmitted to server 118 from client device 102 as a result of a guided photography session or through a separate uploading process.

When generating a custom stencil, stencil generator 124 may generate the custom stencil image and metadata corresponding to the custom stencil image. In some embodiments, stencil generator 124 may employ segmentation model(s) running on ML platform 126 to generate the custom stencil image. Stencil generator 124 may then generate one or more stencils, sub-stencils, or part stencils corresponding to one or more parts of the object depicted in the model image (e.g. a chassis, a front or back wheel, a window, a mirror, a door handle, a headlight, etc.). The stencils, sub-stencils, or part stencils may be implemented using any means to convey a shape or structure of an object or part of an object. For example, stencils, sub-stencils, or part stencils may be a silhouette or outline of an object or part of an object. Stencils, sub-stencils, or part stencils may alternatively be an image or image representation of the corresponding object or part of the object.

Stencil generator 124 may then overlay the generated stencils, sub-stencils, or part stencils (corresponding to the one or more object parts) and obtain a final custom stencil for the object corresponding to the object type. In a non-limiting example, stencil generator 124 may perform segmentation on a model image of a large sedan vehicle viewed from the left side. Stencil generator 124 may then obtain part stencils corresponding to the chassis, the front left wheel, and the rear left wheel. Stencil generator may then overlay the chassis stencil with the front wheel stencil and the rear wheel stencil to obtain a custom stencil image of the large sedan vehicle. Stencils, sub-stencils, part stencils, and custom stencil images may be stored as Scalable Vector Graphics (SVG) files. Alternatively or in addition, they may be stored as JPEG, PNG, TIFF, HEIC, or RAW files. Stencils, sub-stencils, part stencils, or custom stencil images may also be partially opaque or translucent to avoid blocking the viewport of an image capture preview display.

In some embodiments, stencil generator 124 may employ bounding box generation model(s) running on ML platform 126 to generate metadata corresponding to a custom stencil image. In some embodiments, stencil generator 124 may leverage any known bounding box generation tool to perform bounding box generation on a model image of an object (e.g. a vehicle). Stencil generator 124 may then generate one or more bounding boxes corresponding to one or more parts of the object depicted in the model image (e.g. a chassis, a front or back wheel, a window, a mirror, a door handle, a headlight, etc.). From the generated bounding boxes, stencil generator 124 may determine metadata corresponding to each generated bounding box. In some embodiments, stencil generator 124 may determine a coordinate position data for the one or more object. The coordinate position data may include pixel coordinates of the origin or center of the bounding box. For example, the coordinate position data may also include pixel coordinates of a corner of the bounding box (e.g. top-left corner, top-right corner, bottom-left corner, or bottom-right corner). The coordinate position data may also be a normalized continuous value. In one implementation, (0, 0) may be the center of the custom stencil image, and (1, 1) may be the top-right corner of the custom stencil image. In another implementation, (0, 0) may be the top-left corner of the custom stencil image, and (1, 1) may be the bottom-right corner of the stencil image. The determined metadata may also include a size for each determined bounding box. For example, the size may include a pixel length and width value calculated from the bounding box. The length and width of the bounding box size may also be a normalized continuous value. After determining the metadata corresponding to each bounding box, stencil generator 124 may store the associated metadata of the bounding boxes alongside the custom stencil image to thereby generate the custom stencil.

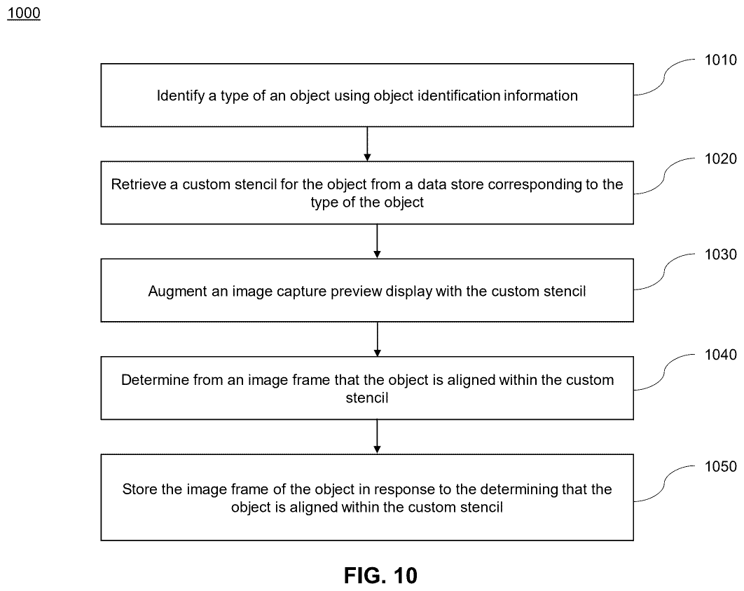

After generating one or more custom stencils corresponding to different types of objects, server 118 may transmit the custom stencils to client device 102 to be stored in client memory 108. Then, when guided photography app 104 identifies an object type, guided photography app 104 may retrieve the corresponding custom stencil stored in client memory 108 for use in the guided photography process, as discussed in more detail with respect to FIG. 10.

One or more components of the guided photography process described above may be implemented within the client device 102, third party platforms, a cloud-based system, server 118, or distributed across multiple computer-based systems.

FIG. 2 illustrates an example block diagram of a client device 102, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 2, as will be understood by a person of ordinary skill in the art.

In some embodiments, the guided photography app 104 may be opened on the client device 102 and guided photography function selected to initiate a guided photography function. A camera may be activated (e.g., camera 106) to communicate a live stream of imagery (e.g., frames of video) from a field of view of the camera 106. A camera may output, for display at client device display 202, a frame (e.g., an image frame or a frame of a video, for example) depicting one or more real-world objects that are viewable by camera 106. For instance, an image may depict a vehicle in a field of view of camera 106. In some embodiments, the image may be provided by a raw image byte stream or by a byte array, a compressed image byte stream or byte array, and/or a partial compressed image byte stream or byte array.

In some embodiments, guided photography app 104 may first identify the type of object using camera 106. In some embodiments, guided photography app 104 may prompt a user to scan object identification information of the object with camera 106. In a non-limiting example, guided photography app 104 may prompt a user to scan the vehicle identification number (VIN) barcode of a vehicle using camera 106. Guided photography app 104 may then identify the vehicle by obtaining a make, model, and/or trim of the vehicle based on the VIN barcode. In some embodiments, guided photography app 104 may simply prompt the user to request the user to input object identification information directly by displaying instructions and data entry fields on client device display 202. Guided photography app may also leverage an ML model and/or computer vision techniques to identify the object using camera 106.

In some embodiments, guided photography app 104 may then retrieve a custom stencil 204 corresponding to an identified object type from client memory 108. For example, if guided photograph app 104 identifies an object as “[MAKE A] [MODEL B]”, guided photography app 104 may retrieve the corresponding stencil 204 stored in client memory 108 for the object type “[MAKE A] [MODEL B]”. Guided photography app 104 may also retrieve associated stencil metadata 206, which may include the coordinate position data of different parts of the object along with a bounding box size corresponding to the different object parts. For example, guided photography app 104 may also retrieve metadata for stencil 204 corresponding to object type “[MAKE A] [MODEL B]” (e.g. coordinate position data and bounding box sizes of a front-left wheel, a rear-left wheel, a front left window, and a left mirror).

In some embodiments, client memory 108 may store multiple stencils associated with an object type. For example, object type “[MAKE A] [MODEL B]” may have 8 associated stencils, each with their own corresponding stencil metadata, namely: a front left view stencil, a front view stencil, a front right view stencil, a right view stencil, a back right view stencil, a back view stencil, a back left view stencil, and a left view stencil. Each stencil 204 may have a different set of associated stencil metadata 206. For example, stencil metadata 206 of a front view stencil of object type “[MAKE A] [MODEL B]” may include coordinate position data and bounding box sizes of a left headlight, a right headlight, a windshield, a left mirror, and a right mirror. In another example, a front left view stencil for the same object type may include coordinate position data and bounding box sizes of a left headlight, a right headlight, a windshield, a left mirror, a front left wheel, a rear left wheel, a front-left window, and a rear-left window.

Guided photography app 104 may then augment an image capture preview display of client device 102 (e.g. client device display 202) with stencil 204. In some embodiments, guided photography app 104 may directly augment client device display 202 with the stencil 204. However, in cases where the resolution of client device display 202 is different than the base resolution of stencil 204, guided photography app 104 may be unable to directly augment client device display 202 with the custom stencil 204. In such cases, guided photography app 104 may scale and/or offset stencil 204 to fit the resolution of client device display 202. In some embodiments, guided photography app 104 may scale the width or height of the custom stencil and pad the missing width or height.

For example, the pixel resolution of a client device display 202 could be 2500×1000 and the pixel resolution of a stencil 204 could be 900×400. Guided photography app 104 may then calculate the scaling ratios for width and height. For this example, the width ratio is 2500/900≈2.8 and the height ratio is 1000/400=2.5. Guided photography app 104 may prefer to pad the missing width/height of a stencil rather than removing/deleting exceeding width or height sections. As such, guided photography app 104 may scale stencil 204 uniformly using the smaller ratio (i.e. 2.5), so the width or height of the scaled stencil does not exceed the resolution of client device display 202. Accordingly, the pixel resolution of scaled stencil 204 is (900)(2.5)×(400)(2.5)=2250×1000. Guided photography app 104 may then pad the width of scaled stencil 204 by 250 pixels, so the final stencil resolution matches up with the client device display resolution (2250+250)×1000=2500×1000.

In some embodiments, stencil metadata 206 may also need to be scaled and/or padded corresponding to a client device display 202. In such embodiments, if the coordinate position data and bounding box sizes of object parts in stencil metadata 206 are stored in pixel units, the pixel values may need to be scaled by the same factor as scaled stencil 204. For example, if the scaling factor for stencil 204 is 2.5, the coordinate values and bounding box sizes may need to be scaled by a factor of 2.5. In some embodiments, if coordinate position data and bounding box sizes of object parts in stencil metadata 206 are stored as normalized continuous values, guided photography app 104 may not need to scale stencil metadata 206 after scaling stencil 204. After performing any necessary scaling or padding operations, guided photography app 104 may augment client device display 202 with the mapped stencil.

In some embodiments, the user of client device 102 may view the live stream of imagery on a UI of the client device display 202, after buffering in image memory 108, which may include a buffer (e.g., frame buffer, video buffer, etc.). Client device display 202 may show the live stream of imagery alongside stencil 204. In some embodiments, guided photography app 104 may crop an image frame from the live stream of imagery obtained by camera 106 to produce cropped image sections using stencil metadata 206. In some embodiments, guided photography app 104 may crop the locations of the image frame based on the specified coordinate position data of each object part and the bounding box sizes associated with each object part. Guided photography app 104 may perform the cropping operations using any known image processing techniques. Upon cropping an image frame, guided photography app 104 may obtain a set of image sections to be communicated to mobile ML platform 112 for further processing.

In some embodiments, the cropped image sections may be implemented by part classification models 208(1)-(N) of mobile ML platform 112, processed, and used to issue a prediction (e.g., a classification result and/or confidence score). This prediction may be transmitted to guided photography app 104 periodically (e.g., after an image has been provided to the predictive ML model) or continuously (e.g., as frames in a continuous image stream are being assessed). In embodiments in which a live stream is provided to the predictive ML model, the prediction output by the predictive ML model may be used to trigger automatic image capture (e.g., selecting and storing and/or transmitting an image frame for further processing).

As shown in FIG. 2, mobile ML platform 112 may include one or more part classification models 208(1)-(N). Traditionally, machine learning models may be implemented on a mobile device using the processing capabilities of the mobile device's CPU and/or GPU. However, a neural processing unit (NPU) or tensor processing unit (TPU) may be also be used, which are optimized for matrix operations, such as matrix multiplication and convolutions, which constitute some of the most common and computationally intensive mathematical operations performed in machine learning. Accordingly, NPUs and TPUs may be optimized for machine learning tasks, and in particular implementing artificial neural networks and deep learning.

Mobile ML platform 112 may include programing interfaces (APIs), programs, libraries, and/or modules that operate on client device 102's CPU, GPU, NPU, and/or TPU. In some embodiments, mobile ML platform 112 may include part classification models 208(1)-(N) that have been trained on ML platform 126 and downloaded onto client device 102 as part of guided photography app 104's installation package. In some embodiments, part classification models 208(1)-(N) may be configured to implement computer vision ML models, such as computer vision-based predictive ML models (e.g., image classification ML models, computer vision-based regression models, etc.). As a non-limiting example, part classification models 208(1)-(N) may be implemented using Apple's Vision framework, supported by Core ML.

In some embodiments, one or more part classification models 208(1)-(N) operating on mobile ML platform 112 may be configured, via training at server 118 and/or client device 102, to categorize an image or cropped image section as either “pass” (containing the corresponding desired object or object part) or “fail” (missing the corresponding desired object or object part). In some embodiments, the part classification models may be further configured to provide a pass/fail confidence score associated with the corresponding pass/fail predictions. For example, in some embodiments, part classification models 208(1)-(N) may be configured to provide both a pass confidence score (e.g., a percentage) predicting whether the image includes the corresponding desired object or object and a fail confidence score (e.g., a percentage) predicting whether the image is missing the corresponding desired object or object. For example, in such embodiments, a part classification model 208(N) may indicate that an image is 91.4% likely to include a corresponding desired object or object part, and 12.1% likely to be missing a corresponding desired object or object part. In some embodiments, the image classification ML model may be configured to provide only a “pass” confidence score indicating a likelihood of whether the image or image section includes the corresponding object or object part. In some embodiments, the part classification model 208(N) may be configured to provide only a “fail” confidence score indicating a likelihood of whether the image or image section is missing the corresponding object or object part. In some embodiments, the part classification model 208(N) may be configured to not provide a confidence score, but only a binary determination (e.g., pass/fail).

In one technical improvement over current processing systems, one or more part classification models 208(1)-(N) on mobile ML platform 112 may be implemented as quantized models. For example, the one or more classification models 208(1)-(N) may be floating point 16-bit quantized models. In this approach, model sizes may be reduced, leading to lower memory usage and faster inference time. As a result, overall processing speed and efficiency may be improved.

In some embodiments the execution of one or more part classification models 208(1)-(N) may be offloaded to server 118 or an edge computing server. In one technical improvement over current processing systems, the offloaded part classification tasks may then be executed in parallel using one or more virtual servers each corresponding to a part classification model, leading to improved efficiency and accuracy.

In some embodiments, after providing an image or image section to a predictive ML model (e.g., part classification model 208(N)), guided photography app 104 (or another component within client device 102) may receive a determination from the predictive ML model regarding a whether the image or image section contains a corresponding desired object part. For example, guided photography app 104 (or any other components) may receive from the predictive ML model a “pass” confidence score that an image section contains a front-left wheel of a vehicle at 99.7% certainty. In another example, guided photography app 104 may receive from the predictive ML model a binary “fail” prediction that an image section does not contain a rear-right window of a vehicle.

In some embodiments, one or more predetermined thresholds may be set within guided photography app 104 indicating a next action by guided photography app 104. For example, guided photography app 104 may set a condition that all of the associated part classification models (e.g. a front-left wheel classification model, a rear-left wheel classification model, a front left window classification model, and a left mirror classification model) must return a “pass” confidence score of 99% or above before an image frame is accepted in the guided photography session. If one or more part classification models 208 return a “pass” confidence score lower than 99%, guided photography app 104 may prompt the user to reposition camera 106. If all the associated part classification models return a “pass” confidence score of over 99%, guided photography app 104 may accept the corresponding image frame and store the image frame within client memory 108.

In some embodiments, guided photography app 104 may set a condition that an image frame may be accepted if a subset or certain subset of associated part classification models return a “pass” confidence score of 99% or above. For example, guided photography app 104 may accept an image frame when a rear-left wheel classification model and a front left window classification model return a “pass” confidence score of over 99% regardless of the confidence scores returned by the other part classification models. This may make the guided photography process more robust to potential noise and variation in real world scenarios, where confidence scores may be lower. After accepting an image frame, guided photography app 104 may reinitiate the guided photography process with the next stencil 204 associated with the object type. For example, after accepting an image frame corresponding to the front-left view stencil of object type “[MAKE A] [MODEL B],” guided photography app 104 may reinitiate the guided photography process with the front view stencil for object type “[MAKE A] [MODEL B].”

While guided photography app 104 is described above as receiving confidence scores and performing actions, other components within guided photography system architecture (e.g., programs or APIs operating on server 118) may perform the operations described above, particularly if the predictive ML model is implemented off of client device 102.

In some embodiments, when a “pass” or “fail” confidence score is used, the predetermined threshold related to may be from 50% to 100%, including subranges. For example, in some embodiments, the predetermined threshold may be from 55% to 100%, from 60% to 100%, from 65% to 100%, from 70% to 100%, from 75% to 100%, from 80% to 100%, from 85% to 100%, from 90% to 100%, or from 95% to 100%.

While confidence scores that are percentages are discussed herein, other types of confidence scores are contemplated, such that a confidence score is not limited to a percentage. Confidence scores may be numbers on a scale, e.g., 0 to 1, 0 to 10, etc.

The technical solution disclosed above allows for a guided photography pipeline using machine learning techniques. This solution streamlines and enhances the object image capture process.

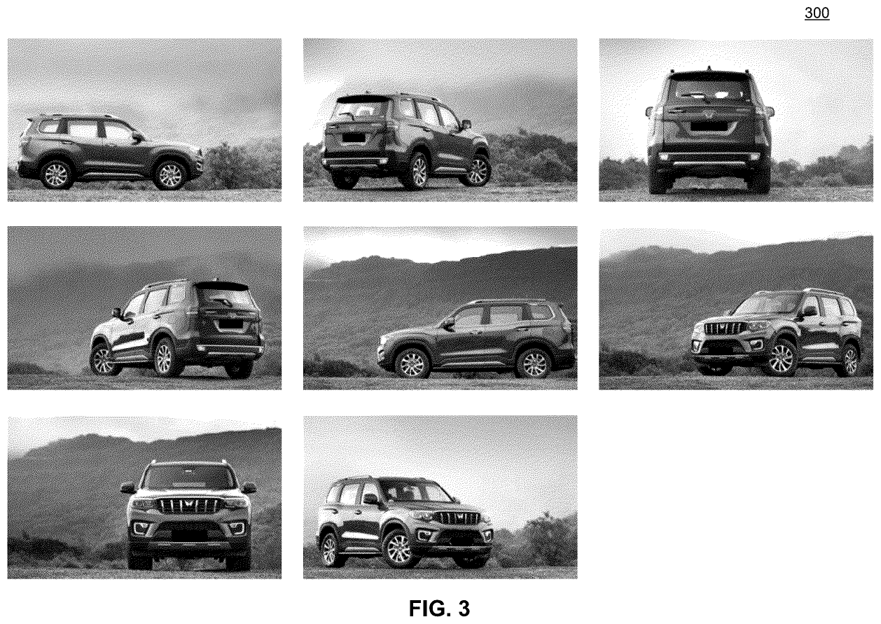

FIG. 3 illustrates example model images, according to some embodiments. A plurality of model images 300 are illustrated as examples of model images that may be used for generating a custom stencil. Model images 300 may represent a target or desired format for standardizing images of objects. For example, an entity or service may want to store standardized images of different vehicles from 8 different angles, namely: a right view, a back right view, a back view, a back left view, a left view, a front left view, a front view, and a front right view. However, there may be an infinite number of different ways to capture images from these angles.

For example, for any given orientation, an image may have a random zoom factor, causing the vehicle to take up varying percentages of the screen. The image may also be rotated by random angles on the x, y, and z axes. Model images 300 may be used to generate custom stencils for guiding a user towards some standard on how the images stored or uploaded to an entity or service should generally appear.

As with the examples described in FIG. 3, specific model image examples have been described herein. However, they are not meant to represent an exhaustive list of possible model images. The scope of the technology disclosed herein is not limited to only these examples.

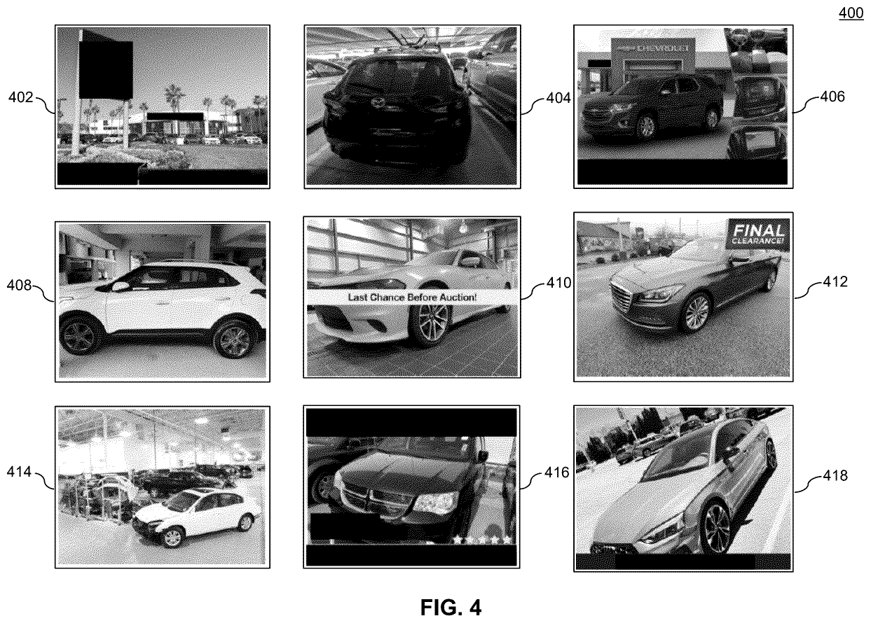

FIG. 4 illustrates example images taken without a guided image capture system, according to some embodiments. A plurality of user images taken without a guided image capture system 400 are illustrated as examples of common obstacles that may arise when cataloging images (e.g. cataloging images of vehicles). An entity or service may want to store images of different vehicles from the 8 different angles listed in the example discussed in FIG. 3. However the exact format and intent of an administrator or manager of the entity or service may be hard to convey in writing or even with model images. Users may interpret instructions or examples differently and potentially produce the example images depicted in FIG. 4.

In 402, it is unclear which vehicle is the subject of the image, as there are a plurality of vehicles within the field of view. In 404, a user may have intended to capture a back view of a vehicle. The image might be passable, but the angle can be improved to better center the backside of the vehicle. In 406, the user has submitted a collage with an exterior shot of the vehicle alongside various interior shots. A different device resolution may also have caused the image to scale automatically and append an empty black area beneath the image.

In 408, the image may be excessively zoomed in, causing portions of the vehicle to be cut off. In 410 and 412, the user has added additional text banners to promote the particular vehicle subject in the image. However, the additional text banners may be blocking the full view of the vehicle. Editing the images may also not be allowed as part of the specified/desired format of the image catalog.

In 414, the image may be excessively zoomed out and also not be centered. In 416, multiple issues may be present in the user image, such as the image being too zoomed in, black sections blocking the full view of the vehicle, and star figures being edited unnecessarily into the image. In 418, the image may be rotated too far along the x and y axes.

While specific example images taken without a guided image system have been described herein, these examples are not meant to represent an exhaustive list of possible images. The scope of the technology disclosed herein is not limited to only these examples.

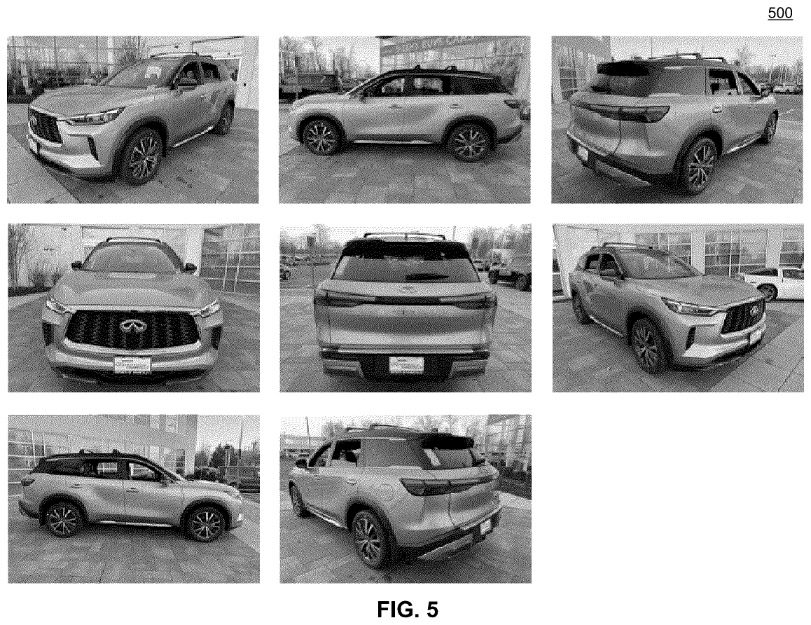

FIG. 5 illustrates example images taken with a guided image capture system, according to some embodiments. A plurality of user images taken with a guided image capture system are illustrated as examples of images following a desired format or standard specified by an entity or service. Following the example from FIG. 3, an entity or service may want to store images of different vehicles from 8 different angles. The guided image capture system may assist a user in capturing an image according to a desired format or standard without having to interpret written instructions or example images. For example, a user may align a vehicle within one or more stencils displayed by a guided photography app to capture the images depicted in FIG. 5.

While specific example images taken with a guided image system have been described herein, these examples are not meant to represent an exhaustive list of possible images. The scope of the technology disclosed herein is not limited to only these examples.

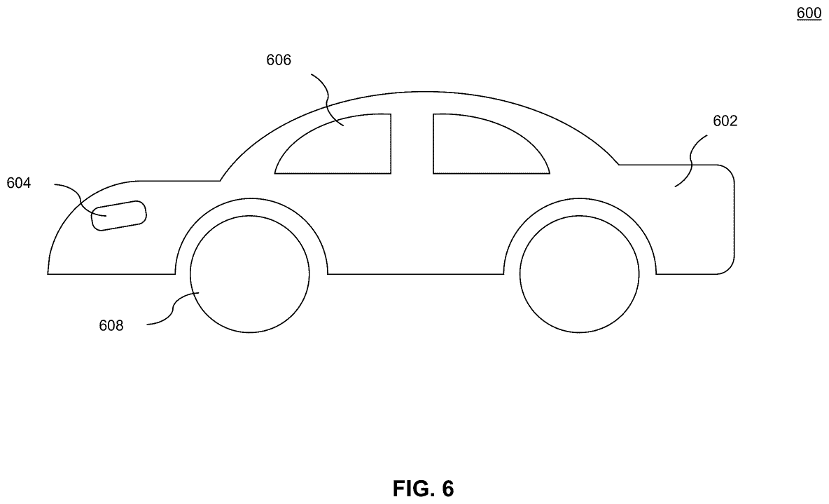

FIG. 6 illustrates an example custom stencil 600, according to some embodiments. Example custom stencil 600 may depict a left view of a vehicle of type “small sedan”. Example custom stencil 600 may include one or more stencils, sub-stencils, or part stencils corresponding to different parts of the object that have been overlaid with each other to generate example custom stencil 600. For example, chassis stencil 602, left headlight stencil 604, front left window stencil 606, and front left wheel stencil 608 may have been overlaid (among additional stencils not depicted) to generate example custom stencil 600. In some embodiments, a guided photography app may augment an image capture preview display with example custom stencil 600 as part of a guided image capture process.

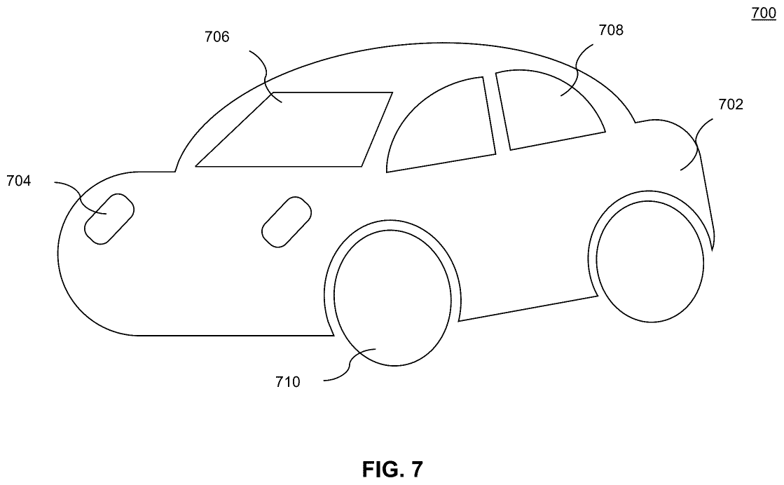

FIG. 7 illustrates another example custom stencil 700, according to some embodiments. Example custom stencil 700 may depict a front left view of a vehicle of type “small sedan”. Generating example custom stencil 700 may involve overlaying chassis stencil 702, right headlight stencil 704, windshield stencil 706, back left window stencil 708, and front left wheel stencil 710 (among additional stencils not depicted). In some embodiments, a guided photography app may augment an image capture preview display with example custom stencil 700 as part of a guided image capture process.

While specific example custom stencils have been described herein, these examples are not meant to represent an exhaustive list of possible custom stencils. The scope of the technology disclosed herein is not limited to only these examples.

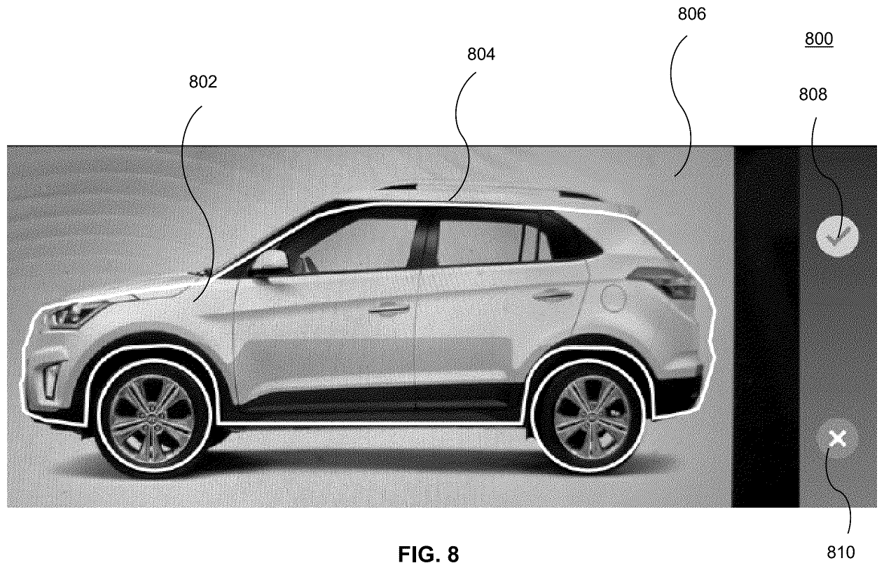

FIG. 8 illustrates an example image capture preview augmentation 800, according to some embodiments. The display augmentation provided in FIG. 8 is merely exemplary, and one skilled in the relevant art(s) will appreciate that many approaches may be taken to provide a suitable image capture preview augmentation 800 in accordance with this disclosure. Example augmentation 800 shall now be described with reference to FIGS. 1-2. However, augmentation 800 is not limited to those example embodiments.

In some embodiments, example image capture preview augmentation 800 may be implemented on client device 102. In some embodiments, image capture preview augmentation 800 may include client device display 806, vehicle 802, custom stencil 804, accept button 808, and reject button 810. In some embodiments, example image capture preview augmentation 800 may be part of a guided photography process. For example, a user may employ a guided photography app 104 to capture a left view of a vehicle. Photography app 104 may augment a client device display 202 with custom stencil 804. A user may then proceed to align vehicle 802 within custom stencil 804.

In some embodiments, a live stream of imagery may be evaluated by guided photography app 104 to determine whether vehicle 802 is aligned within custom stencil 804. In some embodiments, guided photography app 104 may determine that an image frame (from the live stream of imagery or from periodic snapshots) is aligned within custom stencil 804 and display the image frame on client device display 202. At this point, the user may use accept button 808 to accept the image frame. For example, a user may accept an image frame if the user is satisfied with the image. The user may alternatively use the reject button 810 to reject the image frame. For example, a user may reject an image frame if the user is dissatisfied with the image. Guided photography app 104 may then prompt the user to reposition camera 106.

After accepting an image frame, guided photography app 104 may proceed to a subsequent custom stencil (e.g. a front left view of the vehicle). If there are no stencils to capture pictures for, guided photography app 104 may save the captured images in the session and/or transmit them to a server (e.g. server 118). In some embodiments, augmentation 800 may automatically capture and transmit images after determining that the object is aligned within custom stencil 804. In such embodiments, augmentation 800 may not need accept button 808 and reject button 810. This may further streamline the guided image capture process and improve the user experience.

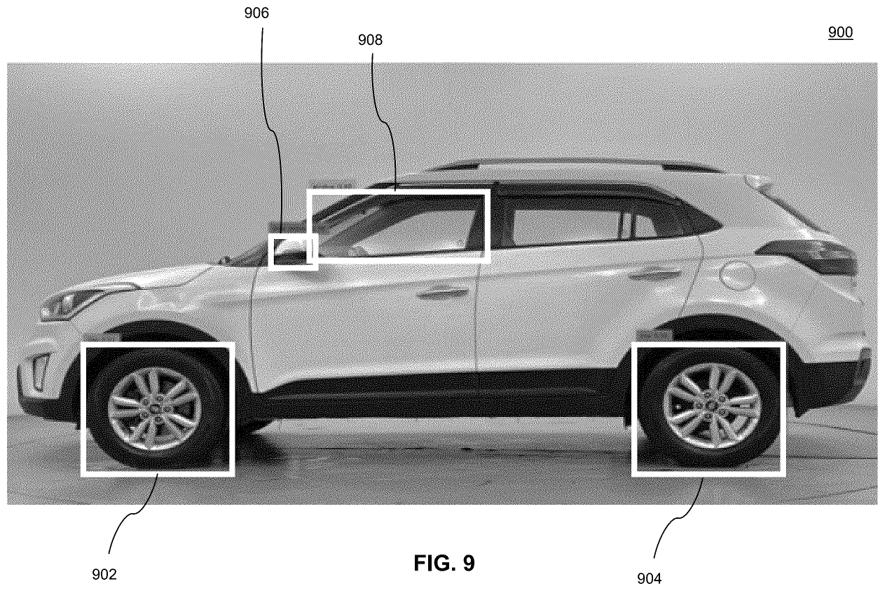

FIG. 9 illustrates an example object part classification 900, according to some embodiments. The part classification depicted in FIG. 9 is merely exemplary, and one skilled in the relevant art(s) will appreciate that many approaches may be taken to provide a suitable object part classification 900 in accordance with this disclosure. Example part classification 900 shall now be described with reference to FIGS. 1-2. However, part classification 900 is not limited to those example embodiments.

In some embodiments, example object part classification 900 may be implemented on client device 102. In some embodiments, object part classification 900 may include image section locations 902, 904, 906, and 908. In some embodiments, example object part classification 900 may be part of a guided photography process. For example, guided photography app 104 may employ object part classification 900 to determine whether an image frame is aligned within a stencil.

In some embodiments, object part classification 900 may first receive an image frame on which to perform object classification during a guided photography session. The session may be associated with a custom stencil (e.g. a left view stencil of a vehicle of type “medium sport utility vehicle (SUV)”), and the custom stencil may have corresponding stencil metadata (e.g. coordinate position data and bounding box sizes for a front left wheel, a left mirror, a front left window, and a rear left wheel). Object part classification 900 may then use the stencil metadata to obtain corresponding image sections.

For example, a coordinate position system may treat the top left corner of an image frame as the origin (e.g. (0, 0)). If the system is normalized, the top right corner may have the coordinates (1, 0), the bottom right corner (1, 1), and the bottom left corner (0, 1). Similarly, the coordinate position system may also treat the top left corner of an image section as the reference origin. For example, the top left corner of an image section location with coordinates (0.5, 0.5) may be positioned (or fixed) in the absolute center of the image. With this coordinate system, example object part classification 900 may obtain the image section location corresponding to “front left wheel” 902 using an associated normalized coordinate position of (0.1, 0.6) and a normalized bounding box size of (0.15)×(0.16), where (0.15) is the bounding box width and (0.16) is the bounding box height. In some embodiments, object part classification 900 may crop the obtained image section location corresponding to “front left wheel” 902 from the image frame to obtain an image section.

Object part classification 900 may repeat this process for the remaining object parts included in the stencil metadata. For example, part classification 900 may then obtain the image section location corresponding to “rear left wheel” 904 using the coordinate position (0.7, 0.6) and bounding box size (0.15)×(0.16). Part classification 900 may then obtain the image section location corresponding to “left mirror” 906 using the coordinate position (0.3, 0.4) and bounding box size (0.06)×(0.04). Finally, part classification 900 may obtain the image section location corresponding to “front left window” 908 using the coordinate position (0.35, 0.25) and bounding box size (0.2, 0.1). After obtaining all the image sections locations, part classification 900 may crop the image section locations to obtain a plurality of image sections corresponding to each object part (e.g. an image section corresponding to the front left wheel, an image section corresponding to the rear left wheel, an image section corresponding to the left mirror, and an image section corresponding to the front left window).

Upon obtaining the plurality of image sections, object part classification 900 may perform part classification on each image section to determine whether the image section contains the corresponding (or desired) object part. In some embodiments, object part classification 900 may use part classification models 208(1)-(N) on mobile ML platform 112 to perform the part classification. In some embodiments, object part classification 900 may obtain a “pass” confidence score indicating a likelihood that the image section contains the corresponding object part. For example, object part classification 900 may determine, using a tire classification model, that the image section corresponding to “front left wheel” has a 99.1% likelihood of containing a “tire” object part. Object part classification 900 may also determine, using the tire classification model, that the image section corresponding to “rear left wheel” has a 99.9% likelihood of containing a “tire” object. Similarly, object part classification 900 may determine, using respective part classification models, that the image section for “left mirror” has a 67% likelihood of containing a “mirror” object part and the image section for “front left window” has a 98.3% likelihood of containing a “window” object part.

From the determined likelihoods, object part classification 900 may determine that the object in the image frame is aligned within the custom stencil in the current guided photography session. For example, object part classification 900 may determine, based on the 67% likelihood associated with the “left mirror” image section, that the medium SUV is not properly aligned within the custom stencil. In this example, it may be the case that the mirror is in a folded position, when the “mirror” classification model was trained to detect and classify mirrors in unfolded positions. In other examples, a mirror may simply be damaged or modified, which may cause the mirror classification model to return a lower confidence score or likelihood.

As such, in some embodiments, object part classification 900 may include different strategies for making a determination based on the classification results. In some embodiments, object part classification 900 may have a strict strategy that requires the confidence scores to all be above a certain threshold (e.g. 99%). In some embodiments, object part classification 900 may allow a certain number of parts or certain object parts to fall below a threshold or have different thresholds. For example, object part classification 900 may set a lower threshold for the image section corresponding to the front left mirror (e.g. 50%).

FIG. 10 illustrates an example flow diagram depicting a method 1000 that can be carried out in line with the discussion above. Method 1000 shall be described with reference to FIGS. 1-9. However, method 1000 is not limited to those example embodiments. One or more of the operations in the method depicted by FIG. 10 could be carried out by one or more entities, including, without limitation, client device 102, server 118, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described facilitate capturing an image with a guided image capture system.

Unless stated otherwise, the steps of method 1000 need not be performed in the order set forth herein. Additionally, unless specified otherwise, the steps of method 1000 need not be performed sequentially. The steps may be performed in a different order or simultaneously. Further, method 1000 may not include all the steps illustrated. For example, in some embodiments, method 1000 may not include step 1010. In some embodiments, method 1000 may not include step 1010, for example, if the guided image capture system is preconfigured to perform guided image capture using preset custom stencils. In such embodiments, the guided image capture system may not need to identify the object type and dynamically retrieve a stencil and may rather use one or more preloaded custom stencils.

Step 1010 may include identifying a type of an object using object identification information. For example, guided photography app 104 may first identify the type of object using camera 106. Guided photography app 104 may then prompt a user to scan object identification information of the object with camera 106. For example, guided photography app 104 may prompt a user to scan the vehicle identification number (VIN) barcode of a vehicle using camera 106. Guided photography app 104 may then identify the vehicle by obtaining a make, model, and/or trim of the vehicle based on the VIN barcode. In some embodiments, guided photography app 104 may simply prompt the user to request the user to input object identification information directly by displaying instructions and data entry fields on client device display 202. Guided photography app may also leverage an ML model and/or computer vision techniques to identify the object using camera 106.

Step 1020 may include retrieving a custom stencil for the object corresponding to the type of the object from a data store. For example, guided photography app 104 may retrieve a custom stencil 204 corresponding to an identified object type from client memory 108. Guided photography app 104 may also retrieve stencil metadata 206 corresponding to stencil 204, which may include the coordinate position data of different parts of the object along with a bounding box size corresponding to the different object parts. In some embodiments, client memory 108 may store multiple stencils associated with an object type, each with a different set of associated stencil metadata. These additional stencils and corresponding metadata may be retrieved alongside stencil 204 at step 1020.

Step 1030 may include augmenting an image capture preview display with the retrieved custom stencil. For example, guided photography app 104 may directly augment client device display 202 with the stencil 204 by displaying stencil 204 in an image capture preview display of client device display 202. In some embodiments, guided photography app 104 may need to scale and/or offset stencil 204 to fit the resolution of client device display 202. In some embodiments, guided photography app 104 may scale the width or height of stencil 204 and pad the missing width or height before displaying stencil 204 on client device display 202.

In some embodiments, stencil metadata 206 may also need to be scaled and/or padded corresponding to a client device display 202. In such embodiments, if the coordinate position data and bounding box sizes of object parts in stencil metadata 206 are stored in pixel units, the pixel values may need to be scaled by the same factor as scaled stencil 204. In some embodiments, if coordinate position data and bounding box sizes of object parts in stencil metadata 206 are stored as normalized continuous values, guided photography app 104 may not need to scale stencil metadata 206 after scaling stencil 204. After performing any necessary scaling or padding operations, guided photography app 104 may then augment client device display 202 with the scaled stencil with the updated metadata.

Step 1040 may include determining from an image frame that the object is aligned within the custom stencil. For example, guided photography app 104 may first receive an image frame on which to perform object classification during a guided photography session from camera 106 or client memory 108. The session may be associated with a custom stencil and the custom stencil may have corresponding stencil metadata. Guided photography app 104 may then use the stencil metadata to obtain corresponding image sections. Guided photography app may repeat this process for the remaining object parts included in the stencil metadata. Upon obtaining the plurality of image sections, guided photography app 104 may perform part classification on each image section to determine whether each image section contains the corresponding (or desired) object part. For example, guided photography app 104 may use part classification models 208(1)-(N) on mobile ML platform 112 to perform the corresponding part classification on each image section. Guided photography app 104 may obtain a “pass” confidence score indicating a likelihood that each image section contains the corresponding object part. From the determined likelihoods, guided photography app 104 may determine that the object in the image frame is aligned within the custom stencil in the current guided photography session.

Step 1050 may include storing the image frame of the object in response to determining that the product is aligned within the custom stencil. For example, guided photography app 104 may save the image frame inside client memory 108. In some embodiments, guided photography app 104 may transmit the image frame to server 118. Server 118 may then perform additional processing on the image frame or simply store the image frame inside memory (e.g. server memory 122).

Alternatively, or in addition, in some embodiments, guided photography app 104 may display the image frame on client device display 202 in response to determining that the product is aligned within the stencil. The user may then be prompted to accept or reject the displayed image frame. This may provide the user with an opportunity to review the decision made by guided photography app 104 and potentially retake an image that may not meet the required formats or standards of the environment, despite passing the checks performed in step 1040. By keeping the user in the loop, the image frames may be checked both by guided photography app 104 and the user before being committed to memory and/or transmitted to server 118, which may lead to higher-quality images overall and images that are more likely to meet the required formats or standards of the environment.

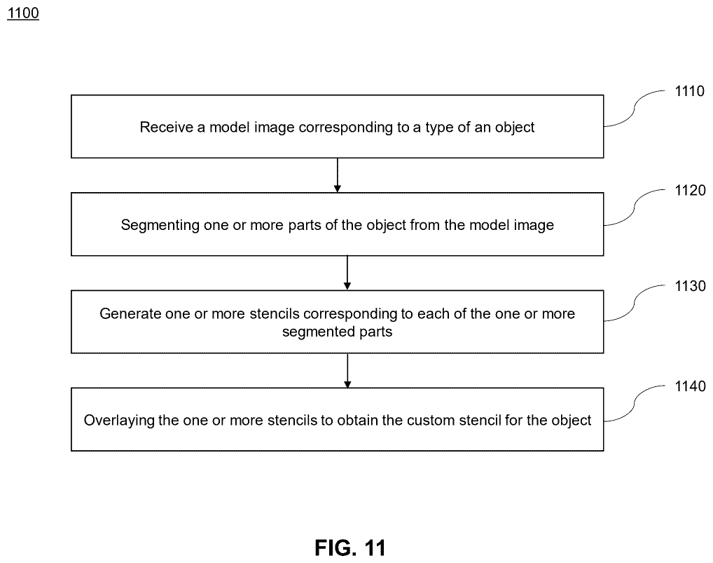

FIG. 11 illustrates an example flow diagram depicting a method 1100 that can be carried out in line with the discussion above. Method 1000 shall be described with reference to FIGS. 1-9. However, method 1100 is not limited to those example embodiments. One or more of the operations in the method depicted by FIG. 11 could be carried out by one or more entities, including, without limitation, client device 102, server 118, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described facilitate generating a custom stencil, according to some embodiments.

Unless stated otherwise, the steps of method 1100 need not be performed in the order set forth herein. Additionally, unless specified otherwise, the steps of method 1100 need not be performed sequentially. The steps may be performed in a different order or simultaneously.

Step 1110 may include receiving a model image corresponding to a type of an object. For example, stencil generator 124 may first receive a model image or target image of an object according to a specific type, such as but not limited to a stock image of a large SUV (left view). The type of the object may be any property of the object that can differentiate that object from objects of a different type (e.g. “large SUV” vehicle can be differentiated over “small sedan” vehicle). A vehicle type may also include a make of the vehicle, a model of the vehicle, and/or a trim of the vehicle. In some embodiments, model or target images may be stored inside server memory 122. Model or target images may also be transmitted to server 118 from client device 102 as a result of a guided photography session or through a separate uploading process.

Step 1120 may include segmenting one or more parts of the object from the model image. For example, stencil generator 124 may employ segmentation model(s) running on ML platform 126 to segment one or more parts of the object (e.g. segmenting a front left wheel, a rear left wheel, a chassis, a front left window, and a mirror from a left view of a vehicle). In some embodiments, stencil generator 124 may leverage the open-source LangSAM model to perform segmentation using text prompts.

Step 1130 may include generating one or more stencils corresponding to each of the one or more segmented parts. For example stencil generator 124 may generate the one or more stencils using the segmented parts obtained at step 1120. The stencils may be implemented using any means to convey a shape or structure of an object or part of an object such as but not limited to, a silhouette or outline of an object part. In some embodiments, the generated stencils may be an image or image representation of the corresponding object part.

Step 1140 may include overlaying the one or more stencils to obtain the custom stencil for the object. For example, stencil generator 124 may employ various image processing techniques to merge the one or more stencils to produce the custom stencil.

These approaches provide a technical solution to effectively enforce a standardized image capture format during an image capture process. The custom stencil generation provides tailored, fine-grained guidance during image capture for different types of objects, improving the accessibility and efficiency of the process as well as the quality of the final image. For example, a user without extensive photography experience or professional equipment may quickly and effectively capture a high quality image that adheres to the required standards and/or formats of an environment (e.g. an entity or service).

In addition, the metadata calculated during the custom stencil generation facilitates improved efficiency and accuracy when determining whether the image is aligned within the stencil. The system may quickly crop the relevant image sections of the object and perform image classification on the individual object parts. This leads to a verification model that can be generalized to any object by relying on the metadata associated with the custom stencil and is thus agnostic to object type. Accuracy may be improved since classifying object parts is a much simpler task for a machine learning models than classifying the entire object. Individual object part scores may be more accurate as a result, and the system will have access to a plurality of scores to make a more informed decision about the object as a whole.

The various aspects solve at least the technical problems associated with standardizing image capture in a multi-user environment. The various embodiments and aspects described by the technology disclosed herein are able to produce high-quality, standardized images without the need for professional equipment or technical knowledge.

### Example Computer System

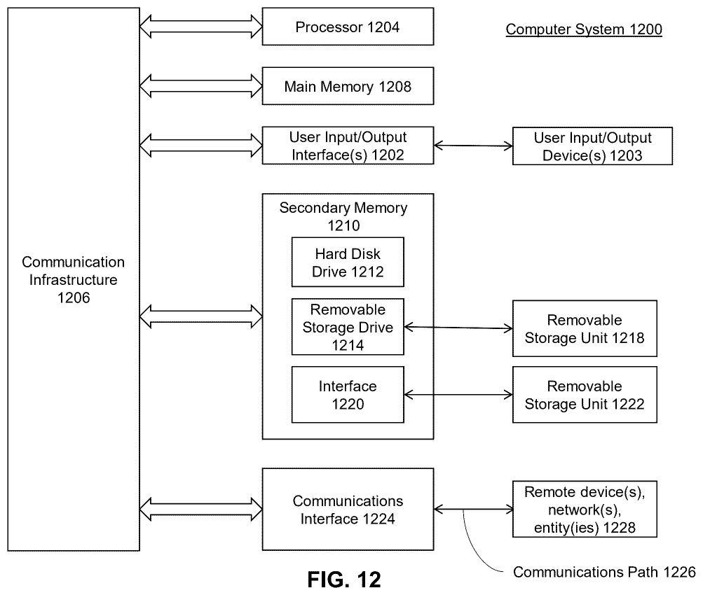

FIG. 12 depicts an example computer system useful for implementing various embodiments.

Various embodiments may be implemented, for example, using one or more well-known computer systems, such as computer system 1200 shown in FIG. 12. One or more computer systems 1200 may be used, for example, to implement any of the embodiments discussed herein, as well as combinations and sub-combinations thereof. For example, the example computer system may be implemented as part of client device 102, server 118, etc. Cloud implementations may include one or more of the example computer systems operating locally or distributed across one or more server sites.

Computer system 1200 may include one or more processors (also called central processing units, or CPUs), such as a processor 1204. Processor 1204 may be connected to a communication infrastructure or bus 1206.

Computer system 1200 may also include customer input/output device(s) 1202, such as monitors, keyboards, pointing devices, etc., which may communicate with communication infrastructure 1206 through customer input/output interface(s) 1202.

One or more of processors 1204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1216. Removable storage unit 1216 may include a computer usable or readable storage device having stored thereon computer software (control logic) and/or data. Removable storage unit 1216 may be a floppy disk, magnetic tape, compact disk, DVD, optical storage disk, and/any other computer data storage device. Removable storage drive 1214 may read from and/or write to removable storage unit 1216.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1216 and 1222, as well as tangible articles of manufacture embodying any combination of the foregoing. Such control logic, when executed by one or more data processing devices (such as computer system 1200), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The breadth and scope of the present disclosure should not be limited by any of the above-described exemplary embodiments, but should be defined only in accordance with the following claims and their equivalents.

What is claimed is:

1. A computer implemented method for an image capture system, comprising:
identifying a type of an object using object identification information;
retrieving a custom stencil for the object from a data store corresponding to the type of the object;
augmenting an image capture preview display with the custom stencil;
determining, based on metadata from an image frame from the image capture preview display, that the object is aligned within the custom stencil; and
storing the image frame of the object in response to the determining that the object is aligned within the custom stencil.

2. The computer implemented method of claim 1, wherein the custom stencil is based on the type of the object.

3. The computer implemented method of claim 1, further comprising:
determining one or more corresponding bounding boxes for one or more parts of the object; and
determining the metadata for the object based on the determined bounding boxes.

4. The computer implemented method of claim 3, wherein the metadata comprises coordinate position data for each of the one or more parts of the object.

5. The computer-implemented method of claim 1, wherein the object is a vehicle.

6. The computer implemented method of claim 1, wherein the determining comprises:
cropping the image frame using the metadata to obtain one or more cropped images;
determining, using a machine learning model, whether the one or more cropped images each contain a corresponding part of the object; and
determining that the object is aligned with the stencil in response to determining that the cropped images each contain the corresponding part of the object.

7. The computer implemented method of claim 6, wherein the corresponding part of the object is a wheel, a window, a mirror, a door handle, or a headlight of a vehicle.

8. The computer implemented method of claim 1, further comprising:
adjusting the custom stencil to a user device based on a resolution of the device.

9. The computer implemented method of claim 1, wherein the object identification information includes a make of a vehicle, a model of a vehicle, and a trim of a vehicle.

10. A system, comprising:
one or more memories;
at least one processor each coupled to at least one of the memories and configured to perform operations comprising:
identifying a type of an object using object identification information;
retrieving a custom stencil for the object from a data store corresponding to the type of the object;
augmenting an image capture preview display with the custom stencil;
determining, based on metadata from an image frame from the image capture preview display, that the object is aligned within the custom stencil; and
storing the image frame of the object in response to the determining that the object is aligned within the custom stencil.

11. The system of claim 10, wherein the custom stencil is based on the type of the object.

12. The system of claim 10, the operations further comprising:
determining one or more corresponding bounding boxes for one or more parts of the object; and
determining the metadata for the object based on the determined bounding boxes.

13. The system of claim 12, wherein the metadata comprises coordinate position data for each of the one or more parts of the object.

14. The system of claim 10, wherein the object is a vehicle.

15. The system of claim 10, wherein the determining comprises:
cropping the image frame using the metadata to obtain one or more cropped images;
determining, using a machine learning model, whether the one or more cropped images each contain a corresponding part of the object; and
determining that the object is aligned with the stencil in response to determining that the cropped images each contain the corresponding part of the object.

16. The system of claim 15, wherein the corresponding part of the object is a wheel, a window, a mirror, a door handle, or a headlight of a vehicle.

17. A non-transitory computer-readable medium having instructions stored thereon that, when executed by at least one computing device, causes the at least one computing device to perform operations comprising:
identifying a type of an object using object identification information;
retrieving a custom stencil for the object from a data store corresponding to the type of the object;
augmenting an image capture preview display with the custom stencil;
determining, based on metadata from an image frame from the image capture preview display, that the object is aligned within the custom stencil; and
storing the image frame of the object in response to the determining that the object is aligned within the custom stencil.

18. The non-transitory computer-readable medium of claim 17, wherein the custom stencil is based on the type of the object.

19. The non-transitory computer-readable medium of claim 17, the operations further comprising:
determining one or more corresponding bounding boxes for one or more parts of the object; and
determining the metadata for the object based on the determined bounding boxes.

20. The non-transitory computer-readable medium of claim 19, wherein the metadata comprises coordinate position data for each of the one or more parts of the object.
